(19) United States
(12) Patent Application Publication
(10) Pub. No.: US 2019/0302753 A1
(43) Pub. Date: Oct. 3, 2019

(54) COMMUNICATIONS INTERRUPTION SYSTEM, COMMUNICATIONS INTERRUPTION METHOD, AND RECORDING MEDIUM

(71) Applicant: PANASONIC INTELLECTUAL PROPERTY MANAGEMENT CO., LTD., Osaka (JP)

(72) Inventors: Takayuki FUJII, Osaka (JP); Kaoru YOKOTA, Hyogo (JP)

(73) Assignee: PANASONIC INTELLECTUAL PROPERTY MANAGEMENT CO., LT D., Osaka (JP)

(21) Appl. No.: 16/366,636

(22) Filed: Mar. 27, 2019

(30) Foreign Application Priority Data
Mar. 30, 2018 (JP) 2018-067833

(51) Int. Cl. G05D 1/00; H04L 29/08; H04L 12/40; G08G 1/0962

(52) U.S. Cl. CPC G05D 1/0011; H04L 67/12; H04L 12/40; G05D 2201/0213; G05D 1/0088; G08G 1/0962; H04L 2012/40215; G05D 1/0055

(57) ABSTRACT

A communications interruption system includes, in an in-vehicle network system in which it is possible to communicate data between a plurality of groups that each include a plurality of communication devices and a communication line, a communicator that receives data from at least one of the plurality of communication devices included in a first group via the communication line, a determiner configured to detect a communication anomaly in the first group based on the data received by the communicator and determine whether to execute a predetermined communications interruption between the plurality of groups based on contents of the communication anomaly detected, and a switcher that executes the predetermined communications interruption. The predetermined communications interruption includes interrupting a flow of the data transmitted from the first group to a group other than the first group.

### CROSS REFERENCE TO RELATED APPLICATION

The present application is based on and claims priority of Japanese Patent Application No. 2018-067833 filed on Mar. 30, 2018. The entire disclosure of the above-identified application, including the specification, drawings and claims is incorporated herein by reference in its entirety.

### FIELD

The present disclosure relates to communications control in anomalous cases in an in-vehicle network system in which Electronic Control Units (ECUs) in a vehicle communicate.

### BACKGROUND

In recent years, vehicles include a large number of ECUs for controlling all parts therein. The ECUs are included in a communications network referred to as in-vehicle network system. The in-vehicle network system is, for example, configured according to the Controller Area Network (CAN) standard specified in the ISO 11898 series, and the ECUs communicate with another via a bus that is a transmission channel for linking thereof.

According to the CAN standard, an ECU that is a transmission node transmits a frame as a message with a predetermined ID (also referred to as message ID) showing the type of the message, and an ECU that is a reception node receives the frame with an ID predetermined for each of the ECUs.

In such an in-vehicle network system, since there is a risk of communication failures or the transmission of malicious messages by hacking ECUs related to driving controls due to cyberattack leading to serious damage threatening the occupant of the vehicle or even their surroundings, various security countermeasures have been devised. For example, a technique is proposed for (i) making it possible to switch the connection state between a communication device and a communication line in the network using a switch, (ii) interrupting the connection with the network by turning off the switch that is connected to a communication device that has been identified as a sender of a malicious message, so that the influence on other communication devices is limited (e.g. Patent Literature (PTL) 1).

### CITATION LIST

### Patent Literature

### [PTL 1]

Japanese Unexamined Patent Application Publication No. 2017-60057.

### SUMMARY

### Technical Problem

However, an unexpected interruption of the network connections cannot be avoided when ECUs that transmit malicious messages (hereinafter, also referred to as spoofed ECUs) posing as another ECU (hereinafter, also referred to as spoofed ECU) cannot be identified correctly, and the safety of the vehicle cannot be guaranteed as an emergency stop or evacuation cannot be executed when the network connections of other secure ECUs are interrupted because of an erroneous detection.

Accordingly, the present disclosure provides a communications interruption system and the like in which it is possible to limit the adverse effects of operations and heighten the security of the vehicle when one or more ECUs that perform malicious operations, possibly including the spoofing of another ECU, exist in the in-vehicle network system.

### Solution to Problem

In order to solve the above problem, a communications interruption system according to an aspect of the present invention includes, in an in-vehicle network system in which it is possible to communicate data between a plurality of groups that each include a plurality of communication devices and a communication line to which the plurality of communication devices are connected, a communicator that receives data from at least one of the plurality of communication devices included in a first group, out of the plurality of groups, via the communication line included in the first group; a determiner configured to detect a communication anomaly in the first group based on the data received by the communicator, and determine whether to execute a predetermined communications interruption between the plurality of groups based on contents of the communication anomaly detected; and a switcher that executes the predetermined communications interruption when the determiner determines to execute the predetermined communications interruption. The predetermined communications interruption includes interrupting a flow of the data transmitted from the first group to a group other than the first group.

A communications interruption method according to an aspect of the present invention to be executed by a processor included in an information processing device connected to an in-vehicle network system in which it is possible to communicate data between a plurality of groups that each include a plurality of communication devices and a communication line to which the plurality of communication devices are connected, includes receiving data from at least one of the plurality of communication devices included in a first group via the communication line included in the first group, detecting a communication anomaly in the first group based on the data received, and determining whether to execute a predetermined communications interruption between the plurality of groups based on contents of the communication anomaly detected, and executing the predetermined communications interruption when it is determined to execute the predetermined communications interruption. The predetermined communications interruption includes interrupting a flow of data transmitted from the first group to any group other than the first group.

A non-transitory computer-readable recording medium for use in a computer according to an aspect of the present invention has a computer program recorded thereon for causing a processor included in the information processing device to execute the above method.

### Advantageous Effects

The present disclosure contributes to (i) limiting adverse effects caused by operations of malicious ECUs—whether or not the malicious ECUs are posing as other ECUs—from spreading to an in-vehicle network system, and (ii) heightening the security of the vehicle.

### BRIEF DESCRIPTION OF DRAWINGS

These and other objects, advantages and features of the disclosure will become apparent from the following description thereof taken in conjunction with the accompanying drawings that illustrate a specific embodiment of the present disclosure.

FIG. 1 is a diagram for describing a configurational example of an in-vehicle network system including a communications interruption system according to an embodiment.

FIG. 2 is a flowchart of an example of a process procedure sequence performed by the communications interruption system according to the embodiment.

FIG. 3 is a diagram for describing a configurational example of an in-vehicle network system including a communications interruption system according to Variation 1 of the embodiment.

FIG. 4 is a flowchart of an example of a process procedure sequence performed by the communications interruption system according to Variation 1 of the embodiment.

FIG. 5 is a diagram for describing a configurational example of an in-vehicle network system including a communications interruption system according to Variation 2 of the embodiment.

FIG. 6 is a flowchart of an example of a process sequence performed by the communications interruption system according to Variation 2 of the embodiment.

FIG. 7 is a diagram for describing a configurational example of an in-vehicle network system including a communications interruption system according to Variation 4 of the embodiment.

FIG. 8 is a sequence diagram of a process sequence performed by the communications interruption system according to Variation 4 of the embodiment and an external communication partner.

### DESCRIPTION OF EMBODIMENT

Underlying Knowledge Forming Basis of Present Disclosure

The communications system mentioned in PTL 1 is provided with the aim of limiting communication devices that transmit false data in a network affecting other communication devices.

More specifically, the communications system determines whether, out of the communication devices connected by a communication line, communication by a transmission source communication device should be prohibited based on data received via a communication line. When the communications system determines that communication should be prohibited, the transmission source communication device is identified, and a connection between the communication device and the communication line is interrupted.

Note that the communication devices are, for example, ECUs, and the communication line is a CAN bus connecting the ECUs. Modern-day vehicles include a large number of ECUs due to the advancement of computerization. In-vehicle network systems include a plurality of CAN buses connecting a plurality of ECUs as described above, and also include a gateway that is a communication device for mediating communication between these CAN buses. A switch is disposed along the communication line connecting each ECU and CAN bus, and the interruption of the connection is executed by turning off the switch corresponding to the identified malicious ECU.

In the above communications system, adverse effects on the in-vehicle network system due to a malicious ECU, e.g. overloads on the gateway and the CAN bus connected to the malicious ECU, are limited since the connection is interrupted in this manner.

In the above communications system, however, malicious ECUs are not correctly identified when the malicious ECU poses as another ECU. The adverse effects on the in-vehicle network system are, therefore, not eliminated as described above even when the communication between the identified malicious ECU and the CAN bus is interrupted.

Accordingly, in order to heighten the security in vehicles that are highly computerized, the inventors have conceived a technique to limit adverse effects on the in-vehicle network system due to a malicious ECU as described above from spreading regardless of whether the malicious ECU is posing as another ECU.

A communications interruption system according to this technique includes, in an in-vehicle network system in which it is possible to communicate data between a plurality of groups that each include a plurality of communication devices and a communication line to which the plurality of communication devices are connected, a communicator that receives data from at least one of the plurality of communication devices included in a first group, out of the plurality of groups, via the communication line included in the first group; a determiner configured to detect a communication anomaly in the first group based on the data received by the communicator, and determine whether to execute a predetermined communications interruption between the plurality of groups based on contents of the communication anomaly detected; and a switcher that executes the predetermined communications interruption when the determiner determines to execute the predetermined communications interruption. The predetermined communications interruption includes interrupting a flow of the data transmitted from the first group to a group other than the first group.

This makes it possible to limit adverse effects caused by communication anomalies spreading to other groups different from the group in which the communication anomaly has occurred regardless of whether there are any malicious ECUs posing as another ECU in the group.

For example, the communicator may receive data from at least one of the plurality of communication devices included in each of the plurality of groups, and the determiner may be configured to detect a communication anomaly in each of the plurality of groups based on the data received by the communicator, and, when the communication anomaly is detected in a second group that is not the first group, the determiner may determine whether to interrupt a flow of data transmitted from the second group, out of the plurality of groups, to the first group as the predetermined communications interruption.

This makes it possible to reliably guard certain groups, e.g. groups that are functionally of great importance, and to more reliably secure the safety of the vehicle when a communication anomaly occurs in the in-vehicle network system.

For example, the predetermined communications interruption may be an interruption of data communication between the first group and all of the plurality of groups other than the first group. The predetermined communications interruption may also be a total interruption of data communication between the plurality of groups.

This makes it possible to more reliably limit adverse effects spreading between groups when a communication anomaly occurs regardless of whether there are any malicious ECUs posing as other ECUs in the in-vehicle network system. The vehicle can especially be more reliably pulled over by, for example, more reliably ensuring the safety of a powertrain domain regardless of in whichever group a communication anomaly has been detected. By eliminating the mutual influence between domains, it becomes possible to correctly recognize the communication conditions of each domain, i.e., whether there is an anomaly in each domain. When a total interruption is performed, it is possible to anticipate a reliable return to a normal state in less time and the time necessary to finish returning to the normal state can also be predicted more accurately since it is possible to execute a process to return to the normal state with a routine procedure.

For example, the communicator may receive data from (i) at least one of the plurality of communication devices included in a second group that is not the first group, and (ii) at least one of the plurality of communication devices included in a third group that is not the first group or the second group; the determiner may be configured to detect a communication anomaly in the second group and the third group based on the data received by the communicator; and when the determiner detects the communication anomaly in the second group and identifies that the communication anomaly is not in the third group, the determiner may be configured to maintain an interruption of the data communication between the first group and the second group, and cancel an interruption of a flow of data transmitted from the third group to the first group, the interruption of the data communication between the first group and the second group, and the interruption of a flow of data transmitted from the third group to the first group being included in the predetermined communications interruption. For example, when the total interruption is executed, the communicator may receive data from at least one of the plurality of communication devices included in a second group that is not the first group, the determiner may be configured to detect a communication anomaly in the second group based on the data received by the communicator, and when the determiner identifies that the communication anomaly is not in the second group, the determiner may be configured to cancel an interruption of a flow of data transmitted from the second group to all of the plurality of groups other than the second group, the interruption of the flow of data being included in the predetermined communications interruption.

This may allow recovering user-friendliness to a certain degree after temporary impairment while ensuring the safety of the in-vehicle network system in which the predetermined communications interruption has been executed.

For example, a vehicle including the in-vehicle network system may have self-driving functionality including a function for pulling over the vehicle. The determiner may be configured to determine whether to pull over the vehicle based on the contents of the communication anomaly detected when the determiner determines to execute the predetermined communications interruption, and output an instruction to cause the vehicle to autonomously pull over when the determiner determines to pull over the vehicle,

This makes it possible to cause the vehicle to autonomously stop outside of the traveling lane of vehicles, e.g. a berm, when the safety of the vehicle cannot be secured sufficiently only with the communications interruption in the vehicle.

For example, a vehicle including the in-vehicle network system may be manually operable, and the determiner may be configured to output an instruction that prompts an occupant of the vehicle to pull over manually when the determiner determines to pull over the vehicle.

This makes it possible, for example, to allow the occupant to become the driver and take the wheel to resume driving or stop the vehicle when the traveling safety of the vehicle cannot be secured sufficiently only with the communications interruption in the vehicle.

For example, the communications interruption system may further include an external communicator that is capable of communicating with an information processing system external to the in-vehicle network system. When the vehicle is pulled over in compliance with the instruction of the determiner, the external communicator may transmit, to the information processing system, information relating to data received from at least one of the plurality of communication devices included in a group from which data transmission to any other group is interrupted during the predetermined communications interruption.

This makes it possible to provide an external entity such as the information processing system with information relating to conditions of the vehicle when the vehicle is stopped since the traveling safety of the vehicle cannot be secured sufficiently only with the communications interruption in the vehicle,

For example, the external communicator may receive a signal from the information processing system for remotely controlling the vehicle.

This makes it possible to cause the vehicle, which has been temporarily stopped to secure the safety thereof, to be moved by remote control.

A communications interruption method according to an aspect of the present invention to be executed by a processor included in an information processing device connected to an in-vehicle network system in which it is possible to communicate data between a plurality of groups that each include a plurality of communication devices and a communication line to which the plurality of communication devices are connected, includes receiving data from at least one of the plurality of communication devices included in a first group via the communication line included in the first group, detecting a communication anomaly in the first group based on the data received, and determining whether to execute a predetermined communications interruption between the plurality of groups based on contents of the communication anomaly detected, and executing the predetermined communications interruption when it is determined to execute the predetermined communications interruption. The predetermined communications interruption includes interrupting a flow of data transmitted from the first group to any group other than the first group.

This makes it possible to limit the adverse effects caused by communication anomalies spreading to other groups different from the group in which the communication anomaly has occurred regardless of whether there are any malicious ECUs posing as other ECUs in the group.

A non-transitory computer-readable recording medium for use in a computer according to an aspect of the present invention has a computer program recorded thereon for causing a processor included in the information processing device to execute the above method.

This makes it possible to limit the adverse effects caused by communication anomalies spreading to other groups different from the group in which the communication anomaly has occurred regardless of whether there are any malicious ECUs posing as other ECUs in the group.

Note that these general or concrete aspects of the present disclosure may be realized in a system, method, integrated circuit, computer program, or a recording medium such as a computer-readable CD-ROM, and may also be realized by optionally combining systems, methods, integrated circuits, computer programs, or recording media.

Hereinafter, the communications interruption system according to an embodiment will be described with reference to the drawings. The embodiment and variations thereof described below each show a specific example in the present disclosure. Therefore, numerical values, components, placements and connections of the components, steps and their order, and the like are mere examples and are not intended to limit the present disclosure. Components in the following embodiment not mentioned in any of the independent claims are described as optional additional components. Moreover, the drawings are schematic diagrams and do not necessarily provide strictly accurate illustrations.

### Embodiment

### 1-1. General Configuration of In-Vehicle Network System

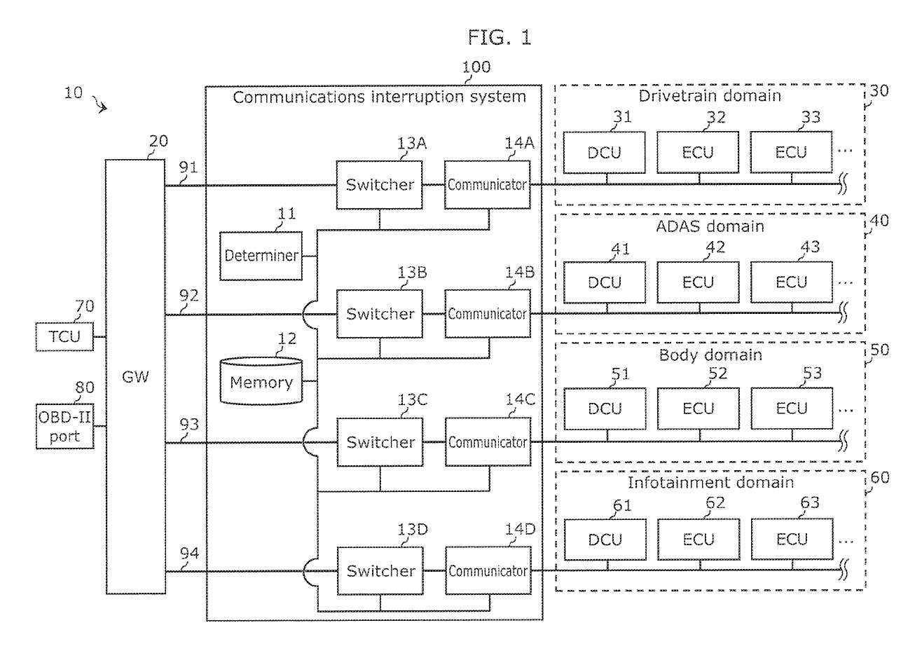

FIG. 1 is a diagram for describing a configurational example of in-vehicle network system 10 according to an embodiment, in-vehicle network system 10 is an example of a communications network that communicates according to a CAN protocol, and is included in a vehicle. The vehicle is, for example, a vehicle and is equipped with a variety of instruments, e.g. an actuator, control device, and sensor (not illustrated),

In-vehicle network system 10 includes gateway (GW in the drawings) 20; communications interruption system 100; communication lines 91, 92, 93, and 94 (hereinafter, also notated as communication lines 91 to 94 when referring to collectively); ECUs 32, 33, 42, 43, 52, 53, 62, and 63 (hereinafter, also simply notated as ECU when referring to collectively or an optional one thereof); Domain Control Units (DCUs) 31, 41, 51, and 61 (hereinafter, also simply notated as DCU when referring to collectively or an optional one thereof); Telematic Control Unit (TCU) 70; and on-board diagnostics II (OBD-II) port 80. In-vehicle network system 10 may further include ECUs other than those mentioned above, but for the sake of description, the above ECUs will be focused on.

The ECUs are, for example, devices hardware of which includes, for example, a processor (i.e. a microprocessor), digital circuit such as a memory, analog circuit, and communication circuit. The memory is read-only memory (ROM), random access memory (RAM), and the like, is stored in a program (i.e., computer program) to be executed by a processor, and retains data for processing by the program. Each ECU, for example, implements various functions for controlling the vehicle and the like due to the processor operating according to the program. The program is configured with a combination of command codes that contain instructions to the processor for implementing a predetermined functionality in each ECU.

Each ECU may be connected to one of the above various instruments. The ECUs to which one of the instruments is connected receive an input of data from one of the instruments and output a signal that contains a command for causing the one of the instruments to perform a predetermined operation. Each ECU is connected to one of communication lines 91 to 94, which are CAN buses, and communicates with other ECUs. However, the communication lines to which each ECU is connected differ in accordance with the functionality of the ECU. For example, ECUs 32 and 33 having drivetrain functionality are connected to communication line 91. For example, ECUs 42 and 43 having advanced driver-assistance system (ADAS) functionality are connected to communication line 92. For example, ECUs 52 and 53 having body functionality are connected to communication line 93. For example, ECUs 62 and 63 having infotainment functionality are connected to communication line 94.

Groups of ECUs that are functionally mutually related in this manner are referred to as domains, and in in-vehicle network system 10 according to the present embodiment, ECUs belonging to one domain are concentratedly connected to a common communication line. In the example of FIG. 1, the domains to which the ECUs, which are connected by communication lines 91 to 94, belong are respectively referred to as drivetrain domain 30, ADAS domain 40, body domain 50, and infotainment domain 60. Each domain includes a DCU that manages the operations of the ECUs belonging to a corresponding one of the domains, and is connected by a corresponding one of the communication lines. Hardware of each DCU may include the same as the ECUs. The above approach for managing ECUs using domains that are groups of the ECUs by functionality thereof can, for example, also be used for facilitating adaption of design between vehicle models.

Each ECU and DCU is an example of a communication device in the present embodiment, and is hereinafter collectively referred to as communication devices.

Communication lines 91 to 94 are connected to gateway 20 and gateway 20 controls the communication between the domains. Gateway 20 may be a device including basically the same components as the ECUs.

TCU 70 connected to gateway 20 is a communication module for enabling communication between in-vehicle network system 10 and an external counterpart of the communication. An example of the external counterpart is a user service provider by a vehicle manufacturer such as a security operations center (SOC). Bodies that provide assistance during emergencies, e.g. roadside assistance providers and first-aid providers, may also be included as candidates of possible external counterparts of the communication.

OBD-II port 80, which is also connected to gateway 20, is an output port for data generated by on-board self-diagnostics functionality. For example, by connecting a predetermined instrument to OBD-II port 80, it is possible to collect Diagnostic Trouble Codes indicating the type of anomaly occurring in the ECUs.

Communications interruption system 100 is located in in-vehicle network system 10 in a position for mediating the connection between gateway 20 and the above four domains. A configuration of communications interruption system 100 and links thereof with the other elements of in-vehicle network system 10 will be described next.

### 1-2. Configuration of Communications Interruption System

Communications interruption system 100 includes communicators 14A, 14B, 14C, and 14D (hereinafter also notated as communicator 14 when referring to collectively or an at least optional one thereof); switchers 13A, 13B, 13C, and 13D (hereinafter also notated as switcher 13 when referring to collectively or an at least optional one thereof); determiner 11; and memory 12.

Communicator 14 is connected between the ECUs and DCU, and gateway 20 by the communication line of each group, and receives data output by the ECUs and DCUs included in the group. In the example in the present embodiment, communicator 14A receives data transmitted from communication devices belonging to drivetrain domain 30. Communicator 14B receives data transmitted from a communication device belonging to ADAS domain 40. Communicator 14C receives data transmitted from communication devices belonging to body domain 50. Communicator 14D receives data transmitted from communication devices belonging to infotainment domain 60. Communicator 14 forwards the received data to determiner 11.

Determiner 11 detects communication anomalies in each group based on the data received from communicator 14. Determiner 11 determines whether to execute a predetermined communications interruption between the groups based on contents of the detected communication anomalies. Communication anomaly here refers to, for example, a situation where at least one ECU in in-vehicle network system 10 is sending a malicious message to the CAN bus to which the at least one ECU is connected. Such a situation is caused by an ECU hacked in a cyberattack, a malicious ECU installed outside the will of the user, a malfunctioning ECU, or the like. Determiner 11 controls switcher 13 and causes this predetermined communications interruption to be executed when determiner 11 determines to execute the predetermined communications interruption. The predetermined communications interruption relates to turning whichever of switchers 13 off, and will be described in more detail later.

Switchers 13A, 13B, 13C, and 13D are disposed between the ECUs and DCUs, and gateway 20 connected by a corresponding one of communication lines 91 to 94 respectively. Switchers 13A, 13B, 13C, and 13D are normally on, and establish a communication path between the ECUs and DCUs, and gateway 20 via the corresponding one of communication lines 91 to 94. Switcher 13 is turned off under control of determiner 11, and this communication path is interrupted, i.e., the communications interruption is executed. In the example in the present embodiment, switcher 13A switches between establishing and interrupting the communication path between the communication devices belonging to drivetrain domain 30 and gateway 20, i.e., the communication path to the other domains. Switcher 136 switches between establishing and interrupting the communication path between the communication devices belonging to ADAS domain 40 and the other domains. Switcher 13C switches between establishing and interrupting the communication path between the communication devices belonging to body domain 50 and the other domains. Switcher 13D switches between establishing and interrupting the communication path between the communication devices belonging to infotainment domain 60 and the other domains.

Note that the position of switcher 13A in the communication path along communication line 91 is not limited to being between communicator 14A and gateway 20 as shown in the example of FIG. 1 as long as switcher 13A is located between drivetrain domain 30 and gateway 20. The same applies to the positions of switcher 13B, switcher 13C, and switcher 13D in their corresponding communication paths.

Memory 12 is ROM, RAM, and the like, and stores a program for implementing functionality from detection of the above communication anomalies to the determining related to the execution of the communications interruption, and retains this data when necessary.

Communications interruption system 100 having the above configuration may be implemented on at least one device including components that are basically the same as the ECUs. Communications interruption system 100 may also be realized as a device in which communications interruption system 100 and gateway 20 are integrated.

### 1-3. Operation

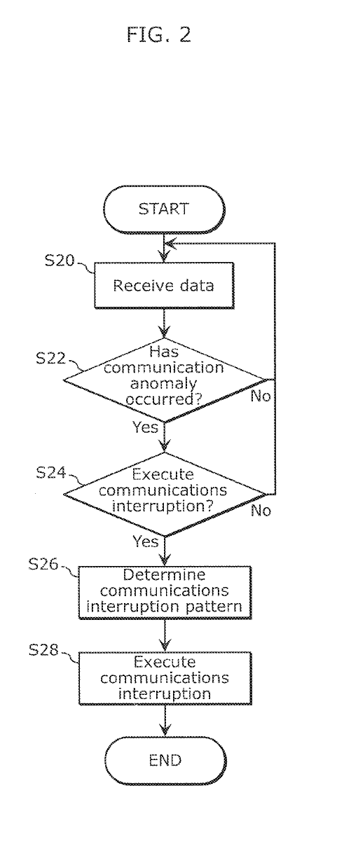

An operation of communications interruption system 100 having the above configuration will be described next. FIG. 2 is a flowchart of an example of a process sequence performed by communications interruption system 100 in in-vehicle network system 10.

Communicators 14 first receive data output to communication lines 91 to 94 by communication devices via the corresponding one of communication lines 91 to 94 to which communicators 14 are connected (step S20).

Determiners 11 next detect communication anomalies, when there is a communication anomaly in the communication lines or the communication devices connected to the communication lines (hereinafter, group may refer to either or both of the communication line and communication device without making any particular distinction therebetween as a place in which a communication anomaly occurs or a subject that is affected by a communication anomaly) based on the data received by communicator 14 (step S22), The communication anomaly can be detected through various methods using information such as reception intervals between messages, degree of deviation from a predetermined transmission cycle of messages with an identical ID, validity of data values, message authentication code, or any combination thereof.

When no communication anomaly is detected (No in step S22), messages in the data are transmitted to gateway 20 via switchers 13, which are on, along the corresponding one of communication lines 91 to 94. Gateway 20 forwards the received messages in accordance with a predetermined rule between communication lines 91 to 94. Then, Communicators 14 each receive a following piece of data (step S20).

When determiner 11 detects a communication anomaly (Yes in step S22), determiner 11 further determines whether to execute the predetermined communications interruption based on the contents of the communication anomaly detected in step S22 (step S24).

The contents of this communication anomaly is information obtained based on the information used in the communication anomaly detection mentioned above, and can also refer to a type of the communication anomaly detected. This type is, for example, determined depending on the place the communication anomaly has occurred (domain or communication lines 91 to 94), the device that is affected by the communication anomaly (ECU, DCU, gateway 20, communication lines 91 to 94, or domain), and the specifics of the adverse effects (effects on steering or acceleration/deceleration control, recognition of objects around the vehicle, doors and the like, vehicle lights, display device, audio equipment, air conditioner, etc).

When determiner 11 determines to execute the communications interruption (Yes in step S24), the specifics of the communications interruption to be executed are also determined. For example, memory 12 stores a table showing associations between the above variety of communication anomalies and patterns of the communications interruption, in other words, whether the communications interruption is necessary for each type of communication anomalies and, when the communications interruption is necessary, the specifics of the communications interruption depending on a degree of the effects of the communication anomaly on the traveling safety of the vehicle. Determiner 11 consults the table and determines whether to execute the communications interruption when determiner 11 obtains the information about the contents of the communication anomaly (step S24). Determiner 11 may also obtain these patterns as information indicating the predetermined communications interruption upon determining to execute the communications interruption (Yes in step S24). In the table, the various types of communication anomalies may be associated with a score or rank depending on the degree of the effects on the traveling safety of the vehicle. In this case, determiner 11 determines whether to execute the communications interruption depending on this score or rank.

As mentioned above, the predetermined communications interruption relates to which switcher 13 will be turned off. The fundamental goal of the communications interruption is to achieve a result in which the flow of malicious messages from a group in which the communication anomaly is detected to at least one other group is interrupted. Hereinafter, examples of communications interruption patterns for achieving such a goal and variations thereof will be given.

(1) For example, switcher 13 corresponding to the group in which the communication anomaly is detected may also be turned off. To give a concrete example, switcher 13C is turned off when a communication anomaly is detected in body domain 50. This makes it possible to achieve to above result. Because communication of the whole group with other parts in in-vehicle network system 10 is interrupted, the adverse effects of the communication anomaly are limited spreading to the other groups and gateway 20 even when false communication devices are posing as another communication device within the same group. There are cases when a malicious ECU in one domain masquerades as another communication device in another domain. The path of cyberattacks that include masquerading of the malicious ECU as another ECU in another group can be cut off by interrupting the communication from a group including a malicious ECU to the other groups.

(2) For example, switchers 13 corresponding to all groups except the group in which the communication anomaly is detected may also be turned off. To give a concrete example, switchers 13A, 13B, and 13D are turned off when a communication anomaly is detected in body domain 50. With this pattern, the above result is obtained, but also data communication between groups in which no communication anomaly is detected is disabled. In addition, there is a risk that the group in which a communication anomaly is detected increases the workload of gateway 20. In this case, however, there is no data for gateway 20 to forward between the groups. Therefore, gateway 20 can, for example, allocate more of its own resources to eliminating this communication anomaly when gateway 20 has functionality to eliminate the communication anomaly.

(3) For example, in the case of a predetermined group that needs to be guarded for continuous safe operation of the vehicle, the switcher corresponding to the predetermined group may also be turned off when a communication anomaly is detected in any group other than the predetermined group. To give a concrete example, in the case that the group including the drivetrain domain might be the above predetermined group, switcher 13A is turned off when a communication anomaly is detected in body domain 50. In other words, with this pattern, the flow of messages from the other groups including the group in which a communication anomaly is detected to the predetermined group that needs to be guarded is interrupted. User-friendliness of the vehicle can be expected to be maintained to a certain degree by limiting the restrictions on the functionality of the whole in-vehicle network system 10 to a minimum while ensuring the safety of the group that need to be guarded. Note that in the above concrete example, only switcher 13A is turned off, but switcher 13C corresponding to the group in which an additional communication anomaly is detected may also be turned off. This makes it possible to aim for limiting the adverse effects from body domain 50 spreading and keeping the restrictions on the functionality of the other two groups in which no communication anomaly is detected at a minimum. There may be two or more of such predetermined groups. In this case, the plurality of switchers 13 corresponding to the predetermined groups may also be turned off every time a communication anomaly is detected in any one of the other groups. A priority degree of which switcher 13 is to be turned off first may be established between the predetermined groups or each group depending on how much the plurality of groups need to be guarded. Determiner 11 selects switchers 13 to be turned off depending on the contents of the detected communication anomaly and starts to turn off the selected switchers with the one corresponding to a group with the highest priority. Whether a group is the predetermined group is not limited to the example in which this is decided depending on the how much the group needs to be guarded from a safety point of view used in the above description, and the group may also be selected by the user, manufacturer, or the like. The same applies to the priority degree.

(4) Redundant communications interruptions may be performed in various forms. Redundant communications interruption here refers to, for example, a case where, upon detecting a communication anomaly in at least one group, not only communications in which the at least one group is in which a communication anomaly is detected but also a group that is transmitter or receiver but also communications in which at least one group is neither transmitter nor receiver are interrupted.

For example, the communication with the group including the drivetrain domain may also be interrupted every time a communication anomaly is detected in any of the other groups. This makes it possible to more reliably pull over the vehicle, which will be described later, by ensuring the safety of the drivetrain domain with more certainty. In this case, when switcher 13 functionally allows it, at least the data flow to the group including the drivetrain domain from all of the other groups is interrupted, but the data flow from the group including the drivetrain domain is not interrupted, and this data may be sent to all of the other groups and be used for monitoring of the vehicle by a driver pulling over of the vehicle, which will described later, or the like.

For example, all switchers 13 may also be turned off when a communication anomaly is detected in one of the groups. Even with such a communications interruption, it is possible to achieve the above effect in which the flow of malicious messages from the group in which a communication anomaly is detected to the other groups is interrupted. False communication devices posing as another communication device in in-vehicle network system 10 and the spreading of adverse effects within in-vehicle network system 10 can be limited swiftly and more reliably regardless of whether this posing happens within a group or between groups. By eliminating the mutual influence between the domains, it becomes possible to correctly recognize the communication conditions of each domain, i.e., whether there is an anomaly or not in each domain. In the case of a configuration for returning from the anomalous state in in-vehicle network system 10, the procedure to return to a normal state afterwards can be set as a routine regardless of the contents of the communication anomaly. There is, therefore, it is possible to anticipate a reliable return to a normal state in less time and the time necessary to finish returning to the normal state can also be predicted more accurately compared to the case where communications interruption in in-vehicle network system 10 includes different group depending on the contents of the communication anomaly.

(5) The condition of the communication anomaly in which all switchers 13 are turned off, which is a derivation of the above (4), may also be limited more. For example, the degree of risks on the traveling safety of the vehicle may also be a condition for turning off all switchers 13. To give a concrete example, all switcher 13 may be turned off when a communication anomaly is detected in a predetermined group that is of great importance in regard to the safety of the vehicle. For example, all switchers 13 may be turned off when a communication anomaly is detected in a predetermined combination of the groups. For example, all switchers 13 may be turned off when a communication anomaly is detected in a predetermined number of the groups or more. Even with such a communications interruption, it is possible to achieve the above effect in which the flow of malicious messages from the group in which a communication anomaly is detected to the other groups is interrupted. By limiting restrictions on the functionality of in-vehicle network system 10 due to the communications interruption, user-friendliness of the vehicle can be maintained to a certain degree when there is a small risk against the safety of the vehicle, and the safety of the vehicle can be secured when there is a high risk.

In this manner, when determiner 11 determines to execute the predetermined communications interruption as illustrated in the above example (from Yes in step S24 to step S26), determiner 11 controls switcher 13 and causes this predetermined communications interruption to be executed (step S28).

Note that when the communications interruption is not executed (No in step S24), the data message may be received by gateway 20 or may be discarded depending on the contents of the communication anomaly detected in step S22.

Information relating to the communication anomaly, e.g. the time, domain, and type of the communication anomaly, messages transmitted during the communication anomaly, and the contents of any processes after detection thereof may be recorded in a log saved in memory 12. All or a portion of the information relating to these communication anomalies may be output from TCU 70 or OBD-II port 80 via gateway 20.

### 1-4. Advantageous Effects

Communications interruption system 100, which includes a plurality of groups in in-vehicle network system 10 in which it is possible to communicate data between the groups, includes communicator 14, determiner 11, and switcher 13.

Communicator 14 receives data from communication devices, such as the ECUs, included in the first group via, out of the plurality of groups, via the communication line included in the first group.

Determiner 11 detects a communication anomaly in the first group based on the data received by communicator 14, and determines whether to execute the predetermined communications interruption between the above plurality of groups based on contents of the detected communication anomaly.

Switcher 13 executes this predetermined communications interruption when determiner 11 determines to execute the predetermined communications interruption,

This predetermined communications interruption includes interrupting a flow of a malicious message transmitted from first group in which the communication anomaly is detected to any other group.

This makes it possible to limit the adverse effects of the communication anomaly spreading from the group in which the communication anomaly is detected to any of the other groups and gateway 20, which forwards data between groups the groups other than the group in which the communication anomaly has been detected. This also makes it possible to limit the adverse effects of a cyberattack spreading from the group including a false communication device that poses as another communication device included in the same group or another group to the other groups and gateway 20.

Communicator 14 may receive data from the communication device included in each of the plurality of groups. Determiner 11 may determine whether to interrupt a flow of data transmitted from the second group to the first group as the predetermined communications interruption when the communication anomaly is detected in the second group that is not the first group.

This makes it possible to limit adverse effects of a communication anomaly in any of the other groups, e.g. the flow of false data including falsified data values, in the first group For example, when the first group is a group that needs to be guarded, it is possible to heighten the safety of the vehicle with regard to threats to safe operation of the vehicle caused by disinformation.

The predetermined communications interruption may also be a total interruption of data communication between the plurality of groups.

This makes it possible to swiftly and more reliably limit the spreading of adverse effects within in-vehicle network system 10 regardless of whether false communication devices are posing as other communication devices within a group or between groups. The vehicle can especially be pulled over more reliably, which will be described later, by ensuring the safety of the drivetrain domain with more certainty, regardless of in which group a communication anomaly is detected. By eliminating the mutual influence between domains, it becomes possible to correctly recognize the communication conditions of each domain, i.e., whether there is an anomaly or not in each domain. Since the procedure for returning to the normal state can be set as a routine, it is possible to anticipate a reliable return to a normal state in less time. The time necessary to finish returning to the normal state can also be predicted with more certainty, and can, for example, be shared with the driver.

### Variations

The technique in the present disclosure is not limited to the above embodiment as an example of the technique according to the present disclosure; various changes, substitutions, additions, omissions, and the like may be made to the embodiment. For example, the following variations are also included in an aspect of the embodiment.

### 2-1. Variation 1

The technique according to the present disclosure can also be used for a self-driving vehicle. The self-driving vehicle using this technique may be caused to pull over from the traveling lane. Hereinafter, a communications interruption system according to Variation 1 will be described with focus on the differences with the embodiment.

### 2-1-1. Configuration

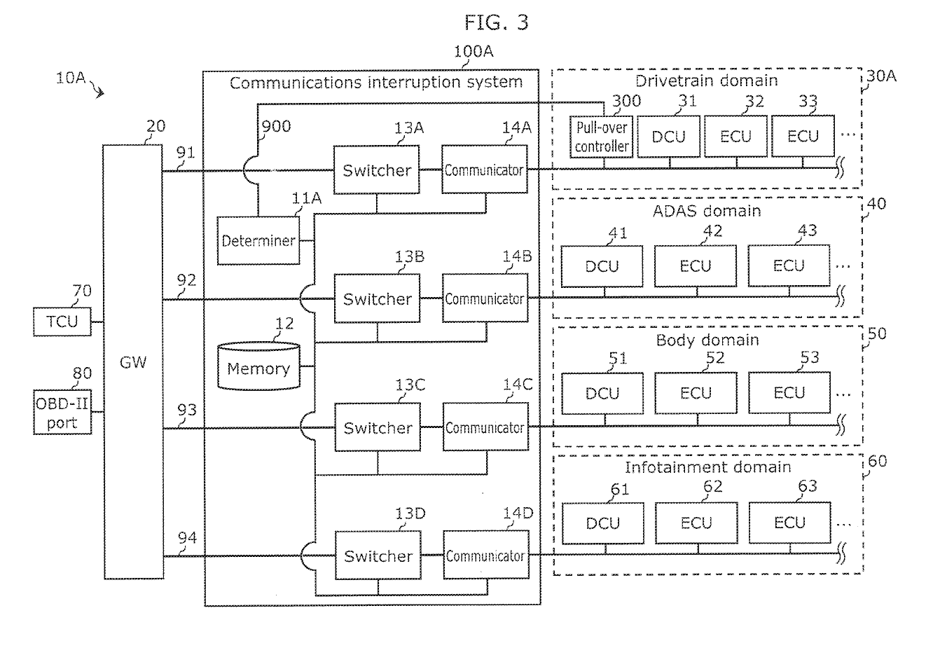

FIG. 3 is a diagram for describing a configurational example of in-vehicle network system 10A including communications interruption system 100A according to the present variation. In-vehicle network system 10A is included in the self-driving vehicle. Note that illustration and description of components providing self-driving functionality during regular operation of the vehicle are omitted,

Communications interruption system 100A includes determiner 11A instead of determiner 11 in the embodiment. Determiner 11A is connected to pull-over controller 300 included in drivetrain domain 30A in the present variation by communication line 900 that is a direct line (dedicated communication line) for securing a communication path that cannot be affected by cyberattacks.

Pull-over controller 300 is, for example, realized on an ECU executing a program providing functionality for causing the self-driving vehicle including in-vehicle network system 10A to pull over.

The control target of this program differs depending on level of automatization of the self-driving vehicle. The description in the present variation assumes a so-called automatization of level 3 (conditional automation) or higher in which steering and acceleration/deceleration control is performed by the self-driving functionality. In other words, the self-driving vehicle is caused to pull over to a berm and the like due to pull-over controller 300 included in drivetrain domain 30A performing the steering and acceleration/deceleration control using the result of the recognition of objects around the vehicle even if the user (driver) is not driving.

A control for providing (i) assistance to the driving for pulling over the vehicle, (ii) a warning alarm prompting the driver to take over the wheel for pulling over or (iii) information for guiding the driver to a suitable location to pull over to is given as an example of the pull over control in a self-driving vehicle with lower automatization. The installation location of the pull-over controller performing such a pull over control is not limited to the drivetrain domain. The warning alarm or providing of information relating to the pulling over functionality may also be included in a vehicle without self-driving functionality.

Determiner 11A determines whether to cause the vehicle to pull over based on the contents of the detected communication anomaly when determiner 11A determines to execute the predetermined communications interruption based on the contents of the detected communication anomaly. This decision may also, for example, be made depending on a score or rank corresponding to the variety of communication anomalies illustrated in the example in the embodiment.

Determiner 11A, having determined to cause the self-driving vehicle to pull over, outputs an instruction to cause the self-driving vehicle to autonomously pull over to pull--over controller 300 via communication line 900.

### 2-1-2. Operation

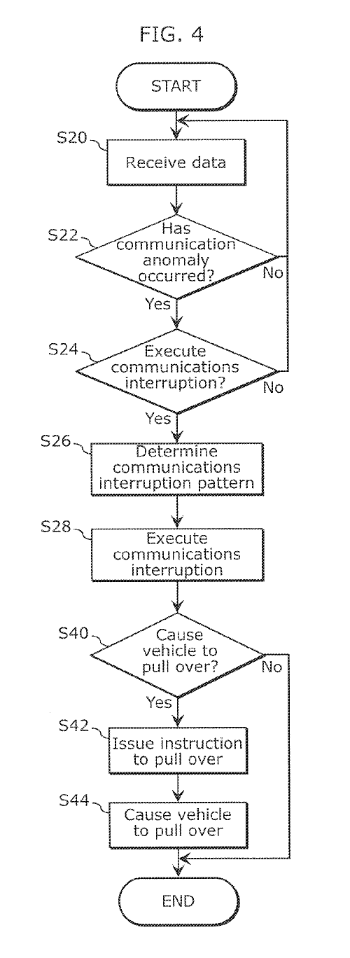

An operation of communications interruption system 100A according to the present variation having the above configuration will be described next. FIG. 4 is a flowchart of an example of a process sequence performed by communications interruption system 100A in in-vehicle network system 10A. In the flowchart of FIG. 4, processes common with the embodiment have the same reference signs, Hereinafter, differences with the embodiment will be mainly described.

Determiner 11A, which controls switcher 13 in step S28 and has caused the predetermined communications interruption to be executed, determines whether to cause the vehicle to pull over based on the contents of the detected communication anomaly (step S40).

When determiner 11A determines to cause the vehicle to pull over (Yes in step S40), determiner 11A outputs an instruction to cause the vehicle to pull over through the self-driving functionality to pull-over controller 300 via communication line 900 (step S42). Pull-over controller 300, which has received this instruction, causes the vehicle to autonomously pull over (step S44).

When determiner 11A determines not to cause the vehicle to pull over (No in step S40), the processes of the communication anomaly detection are terminated.

Note that this is not shown in the flowchart, but the information relating to the decision in step S40 may be recorded in a log or output from TCU 70 or OBD-II port 80 via gateway 20.

### 2-1-3. Advantageous Effects

In in-vehicle network system 10A included in vehicle having self-driving functionality including a function for pulling over the vehicle, determiner 11A may determine whether to pull over the vehicle based on the contents of the detected communication anomaly when determiner 11A determines to execute the predetermined communications interruption. Determiner 11A outputs an instruction to cause the vehicle to autonomously pull over when determiner 11A determines to pull over the vehicle.

This makes it possible to cause the vehicle to autonomously stop when the traveling safety of the vehicle cannot be secured sufficiently only with the communications interruption.

### 2-2. Variation 2

With a self-driving vehicle capable of being operated manually there might be situations when it is safer to pull over the vehicle manually depending on the conditions of the vehicle and the contents of the communication anomaly. Anticipating such cases, communications interruption system 100B according to the present variation may be configured to not cause the vehicle to autonomously pull over in accordance with a decision of the occupant or the determiner. Hereinafter, a communications interruption system according to Variation 2 of the embodiment will be described with focus on the differences with Variation 1 of the embodiment.

### 2-2-1. Configuration

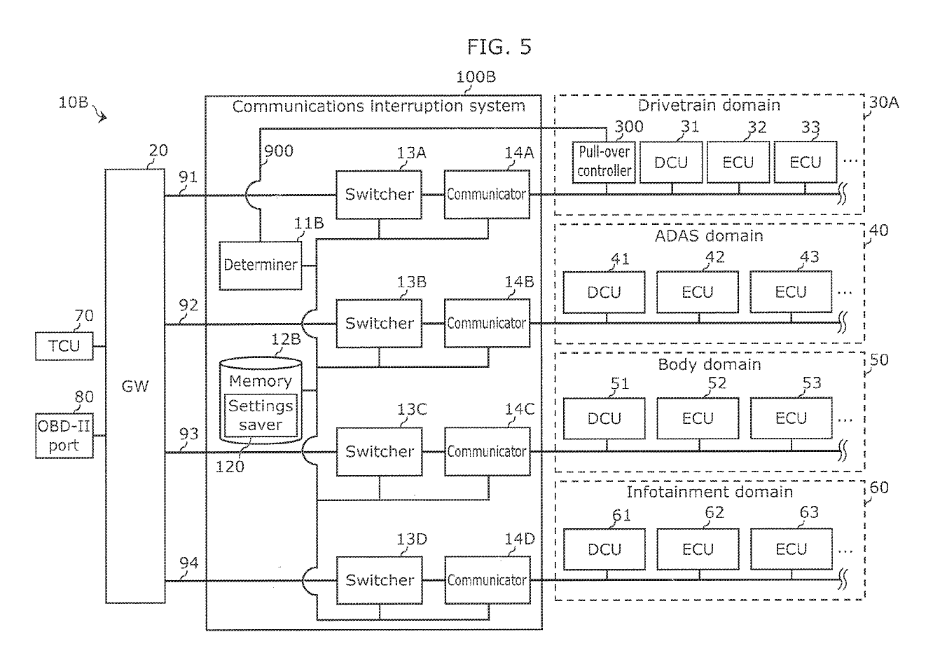

FIG. 5 is a diagram for describing a configurational example of in-vehicle network system 10B including communications interruption system 100B according to the present variation. In-vehicle network system 10B is included in the self-driving vehicle capable of being operated manually, Note that illustration and description of components providing self-driving functionality during regular operation of the vehicle and manual-driving functionality are omitted.

Communications interruption system 100B includes determiner 11B instead of determiner 11 in the embodiment. Communications interruption system 1008 further includes memory 128 instead of memory 12. Memory 128 includes settings saver 120. Settings saver 120 retains settings related to whether to cause the vehicle to autonomously pull over. These settings may be input by the occupant of this vehicle and may also be input by determiner 11B. The input by determiner 11B, for example, reflects the possibility of causing the vehicle to autonomously pull over depending cm the conditions of the vehicle or the contents of the detected communication anomaly, and causes the vehicle to pull over.

Determiner 11B confirms whether a setting for causing the vehicle to autonomously pull over is saved in settings saver 120 before issuing an instruction to pull-over controller 300 to autonomously pull over the vehicle. When the setting for issuing the instruction to autonomously pull over the vehicle is not saved determiner 11B will not issue the instruction to autonomously pull over the vehicle. When the setting for issuing the instruction to autonomously pull over the vehicle is saved, settings saver 120 will issue the instruction to pull over the vehicle similar to determiner 11A in Variation 1.

### 2-2-2. Operation

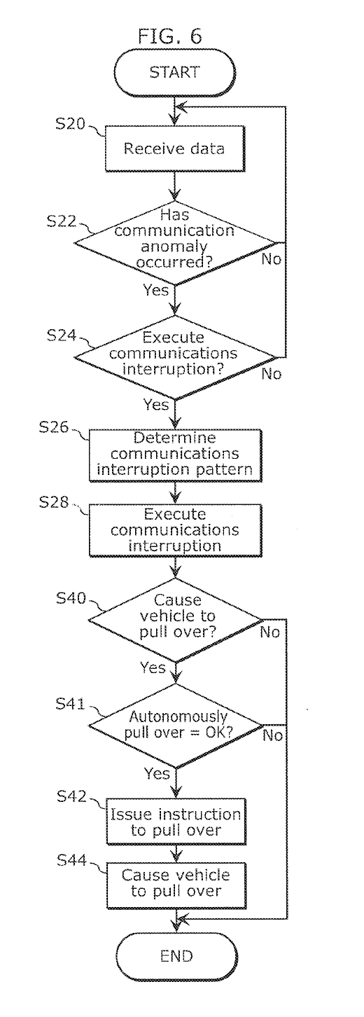

An operation of communications interruption system 100B according to the present variation having the above configuration will be described next. FIG. 6 is a flowchart of an example of a process procedure sequence performed by communications interruption system 100B in in-vehicle network system 10B. In the flowchart of FIG. 6, processes common with the embodiment and Variation 1 have the same reference signs. Hereinafter, differences with the embodiment and Variation 1 will be mainly described.

Determiner 11B, which determines to cause the vehicle to pull over in step S40, confirms whether the setting for causing the vehicle to autonomously pull over is saved in settings saver 120 (step S41).

When the setting is saved (Yes in step S41), determiner 11A outputs an instruction to cause the vehicle to autonomously pull over to pull-over controller 300 via communication line 900 (step S42). Pull-over controller 300, which has received this instruction, causes the vehicle to autonomously pull over (step S44).

When the setting is not saved (No in step S41), the processes of the communication anomaly detection are terminated. This is not shown in the flowchart, but in this case, an instruction for causing the occupant to manually pull over the vehicle, the alarm warning urging the pulling over, or information relating to assistance with the pulling over may also be provided.

Note that this is not shown in the flowchart, but the information relating to the decision in step S41 may be recorded in a log or output from TCU 70 or OBD-II port 80 via gateway 20.

### 2-2-3. Advantageous Effects

Communications interruption system 100B included in the vehicle, which has self-driving functionality and is capable of manual operation, may further include settings saver 120 that saves settings relating to whether to cause the vehicle to autonomously pull over. Determiner 11B included in communications interruption system 100B does not output the instruction for causing the vehicle to autonomously pull over when the setting for causing the vehicle to autonomously pull over is not saved in settings saver 120.

This makes it possible to allow the user to keep driving or cause the user to stop the vehicle when the traveling safety of the vehicle cannot be secured sufficiently only with the communications interruption in the vehicle.

Note that the technique according to the present variation can also be used in a vehicle that is operated manually without self-driving functionality by instructing the driver to manually pull over the vehicle when a communication anomaly is detected and the determiner determines that the vehicle is to be pulled over (Yes in step S40).

### 2-3. Variation 3

The description of the embodiment touched upon the subject of the effects of a redundant communications interruption that includes interruption of communication between groups other than the group in which a communication anomaly is detected or total interruption of communication between all the groups. In the communications interruption system according to the present disclosure, the data flow between the groups that is temporarily interrupted upon detection of communication anomaly may be canceled, i.e., communication between groups may be restored.

For example, as illustrated in FIG. 1, there may be cases where communicators 14 have a configuration in which data from corresponding groups can be received even when switchers 13 are off. One of determiners 11, which has turned off a corresponding one of switchers 13 through the predetermined communications interruption, further determines whether a communication anomaly is occurring in the group corresponding to switcher 13 based on the data received by communicator 14 from the group. When a communication anomaly is not occurring in the group, the flow of data transmitted from the group to the other groups may be exempted from the predetermined communications interruption, i.e., the communications interruption may be canceled,

This makes it possible to alleviate the functionality restrictions due to the communications interruption, and limit the drop in user-friendliness of the vehicle when a communication anomaly is occurring. For example, a redundant communications interruption for ensuring the safe operation of the vehicle may be temporarily executed as the predetermined communications interruption. Especially the functionality restrictions when all switchers 13 are turned off are typically severe and greatly impair user-friendliness of the vehicle. In this manner, however, the user-friendliness, which is temporarily impaired, can be improved by identifying a group in which no communication anomaly is detected and by executing a process to return to a normal state in which the flow of data from the group to the other groups via gateway 20 is allowed again based on the data received by communicator 14.

This operation may also be performed by determiner 11A in the above Variation 1 or determiner 11B in the above Variation 2. The vehicle that has been temporarily caused to pull over and kept stop may also be returned to a state in which driving is possible again as a result of alleviating the functionality restrictions caused by such an interruption.

### 2-4. Variation 4

In the state in which the vehicle is caused to pull over from the traveling lane and stopped when a communication anomaly is detected as in communications interruption system 100A according to Variation 1, the vehicle may also be capable of moving via a vehicle-external control.

This makes it possible to cause the pulled over vehicle to move when necessary when the vehicle cannot be operated safely manually or autonomously by an in-vehicle system.

### 2-4-1. Configuration

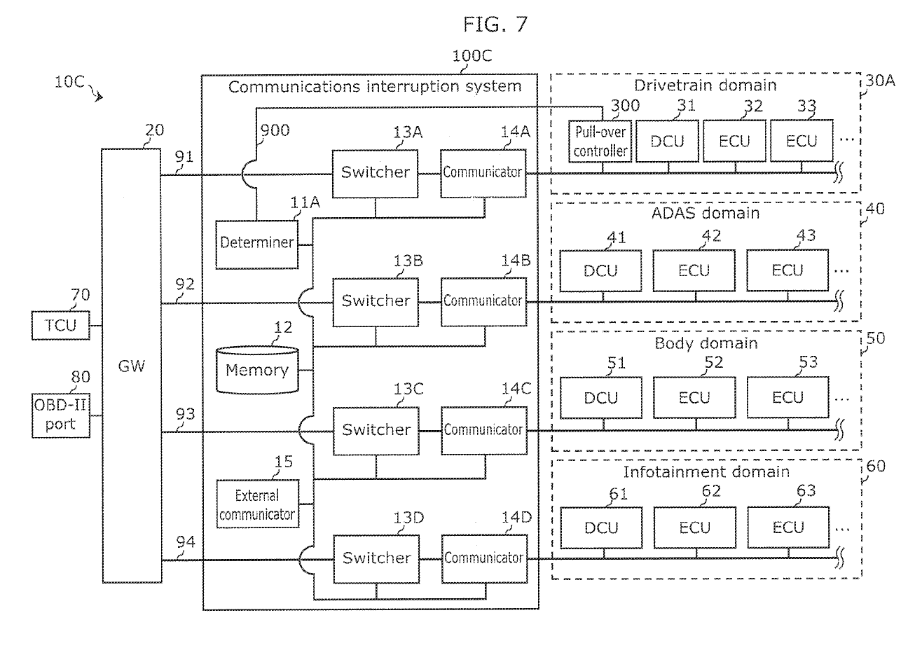

FIG. 7 is a diagram for describing a configurational example of in-vehicle network system 10C including communications interruption system 100C according to the present variation. In-vehicle network system 10C is included in the self-driving vehicle. Components providing manual-driving functionality may or need not be further included in this self-driving vehicle. Hereinafter, a communications interruption system according to the present variation will be described with focus on the differences with Variation 1 of the embodiment.

Communications interruption system 100C includes external communicator 15 along with the configuration of communications interruption system 10A in Variation 1.

External communicator 15 is communicably connected to each communicator 14. External communicator 15 further communicates with a system which is capable of externally controlling the vehicle equipped with in-vehicle network system 10C, e.g., an SOC information processing system (not illustrated), via gateway 20 and TCU 70. Hereinafter, an example of a communication partner of external communicator 15 being this information processing system will be described.

External communicator 15 collects information about each group via communicators 14. In the example of information that can be collected (hereinafter, referred to as vehicle information), a communication log between the communication devices included in the groups is given. An operation log of instruments connected to these communication devices and information obtained through the operation of the instruments, e.g. images of the surroundings of the vehicle, the results of the object recognition, positional information of the vehicle, and the time may also be included. The vehicle information is then transmitted to the information processing system.

In the information processing system, control contents for causing the vehicle to move are determined based on the vehicle information provided from the stopped vehicle through external communicator 15, and then a control signal for executing this control is transmitted to the vehicle. In other words, this information processing system executes remote control of the vehicle that is stopped due to being pulled over.

External communicator 15 receives this control signal via TCU 70 and gateway 20, and then forwards the control signal to the domains corresponding to the functionality necessary for driving the vehicle, e.g. the drivetrain domain, via communicators 14.

This allows the vehicle to move again when the vehicle cannot be controlled to move again by the in-vehicle system or manually after the vehicle is pulled over.

Note that external communicator 15 may also obtain the vehicle information to provide to an external information processing system by obtaining data stored in memory 12 from communicators 14 instead of collecting the vehicle information directly from each communicator 14.

External communicator 15 may also process the collected vehicle information first, and then provide the processed vehicle information to the external information processing system. Examples of this processing include extracting a necessary portion from the vehicle information and determining the conditions of the vehicle and surroundings thereof based on this information.

External communicator 15 as mentioned above may also be used in combination with the communications interruption system according to Variation 2 or Variation 3.

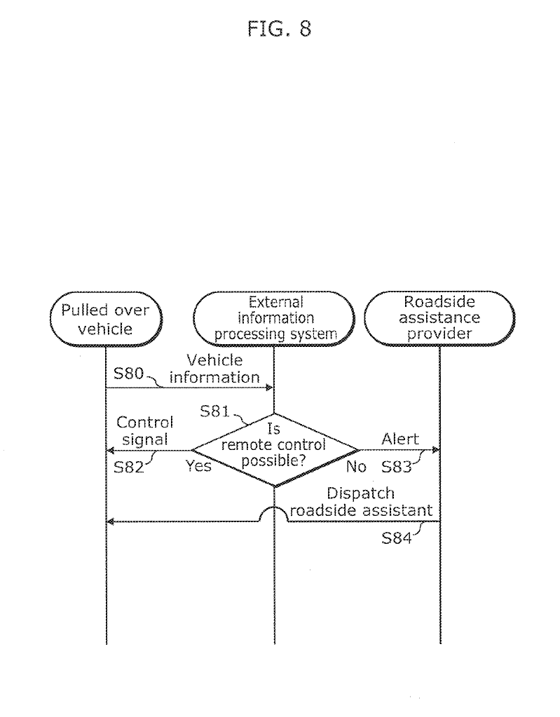

The external information processing system may also further determine whether it is possible to remotely control the vehicle based on the received vehicle information. When it is determined that it is not possible to remotely control the vehicle, the information processing system may, for example, alert a roadside assistance provider. FIG. 8 is a sequence diagram of a process procedure sequence up until this alert.

The vehicle information is first transmitted from external communicator 15 of the pulled over vehicle to the information processing system that is, for example, an SOC (step S80).

The information processing system determines whether it is possible to remotely control the vehicle based on the received vehicle information (step S81).

When remote control is possible (Yes in step S81), the control signal is transmitted from the information processing system to the vehicle (step S82).

When remote control is not possible (No in step S81), the information processing system alerts a roadside assistance provider (step S83). The information processing system provides information relating to the position and type of the vehicle, the specifics of the problem, and the like to the roadside assistance provider.

The roadside assistance provider, upon receiving this dispatches a roadside assistant to the vehicle (step S84).

In this manner, communications interruption system 100C, which pulls over the vehicle from the traveling lane due to the communication anomaly in the in-vehicle network system, includes external communicator 15 that is capable of communicating with an external information processing system.

When the vehicle is pulled over in compliance with the instruction of determiner 11A, external communicator 15 transmits, to the information processing system, vehicle information relating to data received from at least one of the plurality of communication devices included in a group from which data transmission to any other group is interrupted during the predetermined communications interruption.

This makes it possible to provide a vehicle-exterior assistance system with information relating to the conditions of this vehicle when the vehicle is stopped since the traveling safety of the vehicle cannot be secured sufficiently only with the communications interruption.

External communicator 15 may receive a signal from this external information processing system for remotely controlling the vehicle.

This makes it possible to move the vehicle, which has been temporarily stopped to secure the safety thereof, by remote control.

### 2-5. Other Variations

(1) The data received by communicator 14 and provided to determiner 11 does not have to be transmitted from all communication devices included in each domain as long as the data allows determiner 11 to detect communication anomalies in the domains or communication lines. For example, communicator 14 may receive the data only from part of the communication devices in the respective domains.

(2) Communicators 14 corresponding to each group need not be physically independent from one another and may also be logically independent, The same applies to switchers 13, which may also be logically independent.

(3) Four domains are included in each of the in-vehicle network systems in the above examples, but the number of domains in the in-vehicle network systems is not limited thereto. The communication of all of the domains does not have to be interrupted or monitored by the communications interruption system according to the present disclosure, and only a portion of the communication may be subject thereto.

(4) In the in-vehicle network system that can be used by the communications interruption system according to the present disclosure, a configuration in which the DCUs are replaced by an integrated DCU is possible. Each of the above communications interruption systems can be further integrated with the integrated DCU. The communications interruption systems may also be implemented in an integrated fashion with the gateway as the in-vehicle computer or partial functionality thereof.

(5) A data format in which data is communicated in the in-vehicle network system according to the CAN protocol in the above embodiment and variations thereof may be either a standard ID format or an extended ID format.

(6) The above CAN protocol may be interpreted broadly as including derivative protocols, e.g. Time-Triggered Can (TTCAN) and CAN with Flexible Data-Rate (CANED). A network in which the in-vehicle network system, which is capable of being adopted in the communications interruption system according to the present disclosure, is used for the communication between the ECUs is not limited to a network following the CAN protocol. For example, a network in which ECUs communicate data between one another may also follow protocols other than CAN, e.g. Ethernet (registered trademark), Local Interconnect Network (LIN), Media Oriented Systems Transport (MOST (registered trademark)), FlexRay (registered trademark), and BroadR-Reach.

(7) Each ECU in the above embodiment is defined as a device including, for example, a processor (i.e. a microprocessor), digital circuit such as a memory, analog circuit, and communication circuit, but may also include other hardware components such as a hard disk and display. The functionality of each component described in the above embodiment may also be implemented by dedicated hardware (e.g. digital circuit) instead of a processor executing a program in which the functionality of the component is stored.

(8) The dividing of the functionality between the components shown in the communications interruption system according to the present disclosure is an example for the sake of description, but this dividing of the functionality may be altered optionally, and the functional components may be further subdivided.

(9) The execution of each procedure shown in the above embodiment (e.g. the procedures shown in FIGS. 2, 4, and 6) is not necessarily limited to the above order, and the order may be changed, multiple procedures may be performed in parallel, and portion of the procedures may be omitted as long as they do not depart from the scope in the present disclosure and no inconsistencies are introduced. For example, in the procedure shown in FIG. 6, confirming whether the setting for causing the vehicle to pull over is saved (step S41) may also be performed before determining whether to cause the vehicle to pull over (step S40).

(10) A portion or all of the components included in each device in the above embodiment may be included on one system large-scale integrated (LSI) circuit. A system LSI is the integration of a plurality of components on one chip and is manufactured with very large functionality, to be specific, is a computer system including a microprocessor, ROM, RAM, and the like. The ROM is stored in a computer program. The system LSI circuit achieves this functionality due to the microprocessor operating in accordance with the computer program.

Each of the components including the above devices may be included on one individual chip or a portion or entirety thereof may also be included on one chip. System LSI was chosen here, but this may also refer to integrated circuit (IC), LSI, super LSI, and ultra LSI depending on the degree of integration. A means for the IC is not limited to LSI, and may also be implemented using a dedicated circuit or general-purpose processor. After manufacturing the LSI circuit, a field-programmable gate array (FPGA) that can be programmed or a reconfigurable processor in which the connections and settings of the inside of the LSI circuit cells can be reconfigured may also be used. When new techniques for making ICs replacing LSI emerge due to the advancement of semiconductor technology or different derivative technology, the function blocks may naturally be integrated using those techniques. The application in bio technology and the like is possible.

(11) A portion or the entirety of the components including the above devices may also be included on a detachable IC card or standalone module. The IC card or module is a computer system including a microprocessor, ROM, RAM, and the like. The IC card or module may also include the above LSI circuit with very large functionality. The IC card or module achieve this functionality due to the microprocessor operating according to the computer program. This IC card or module may be tamper resistant.

(12) An aspect of the present disclosure may, for example, also be a information processing method including the entirety or a portion of the procedures shown in FIGS. 2, 4, 6, or the like.

An aspect of the present disclosure may also be a program (computer program) executed by a computer for realizing a predetermined information processes according to this information processing method, and may also be a digital signal including the program.

An aspect of the present disclosure may also be recorded on a computer-readable recording medium with the above computer program or a digital signal of data including this computer program, e.g. a floppy disk, hard drive, CD-ROM, magneto-optical drive, DVD, DVD-ROM, DVD-RAM, Blu-ray (registered trademark) Disc (BD), or semiconductor memory.

Additionally, an aspect of the present disclosure may also be transmitted via a network typically being a telecommunications line, radio or cable communications line, or the internet; datacasting; and the like that transmits the computer program or digital signal.

An aspect of the present disclosure may also be a computer system including a micro-processor and memory, the memory may contain the above computer program, and the micro-processor may operate following instructions of the computer program, An aspect of the present disclosure may also be implemented by transferring the program or digital signal to a recording medium, transferring the program or digital signal via a network and the like, or as a different independent computer system.

(13) Forms realized by optionally combining components and functions in the embodiments and variations thereof which are within the scope of the essence of the present disclosure are included in the present disclosure.

Although only one exemplary embodiment of the present disclosure have been described in detail above, those skilled in the art will readily appreciate that many modifications are possible in the exemplary embodiment without materially departing from the novel teachings and advantages of the present disclosure, Accordingly, all such modifications are intended to be included within the scope of the present disclosure.

### INDUSTRIAL APPLICABILITY

The present disclosure can be used in an in-vehicle network system for allowing ECUs installed in a vehicle to communicate, and is helpful for improving the safety of the network and the driving operation of the vehicle.

1. A communications interruption system, comprising:
in an in-vehicle network system in which it is possible to communicate data between a plurality of groups that each include a plurality of communication devices and a communication line to which the plurality of communication devices are connected,
a communicator that receives data from at least one of the plurality of communication devices included in a first group, out of the plurality of groups, via the communication line included in the first group;
a determiner configured to detect a communication anomaly in the first group based on the data received by the communicator, and determine whether to execute a predetermined communications interruption between the plurality of groups based on contents of the communication anomaly detected; and
a switcher that executes the predetermined communications interruption when the determiner determines to execute the predetermined communications interruption, wherein
the predetermined communications interruption includes interrupting a flow of the data transmitted from the first group to a group other than the first group.

2. The communications interruption system according to claim 1, wherein
the communicator receives data from at least one of the plurality of communication devices included in each of the plurality of groups, and
the determiner is configured to detect a communication anomaly in each of the plurality of groups based on the data received by the communicator, and, when the communication anomaly is detected in a second group that is not the first group, determine to interrupt a flow of data transmitted from the second group, out of the plurality of groups, to the first group as the predetermined communications interruption.

3. The communications interruption system according to claim 1, wherein
the predetermined communications interruption is an interruption of data communication between the first group and all of the plurality of groups other than the first group.

4. The communications interruption system according to claim 3, wherein
the communicator receives data from (I) at least one of the plurality of communication devices included in a second group that is not the first group, and (ii) at least one of the plurality of communication devices included in a third group that is not the first group or the second group,
the determiner is configured to detect a communication anomaly in each of the second group and the third group based on the data received by the communicator, and
when the determiner detects the communication anomaly in the second group and indentifies that the communication anomaly is not in the third group, the determiner is configured to maintain an interruption of the data communication between the first group and the second group, and cancel an interruption of a flow of data transmitted from the third group to the first group, the interruption of the data communication between the first group and the second group, and the interruption of a flow of data transmitted from the third group to the first group being included in the predetermined communications interruption.

5. The communications interruption system according to claim 1, wherein
the predetermined communications interruption is a total interruption of data communication between the plurality of groups.

6. The communications interruption system according to claim 5, wherein
the communicator receives data from at least one of the plurality of communication devices included in a second group that is not the first group,
the determiner is configured to detect a communication anomaly in the second group based on the data received by the communicator, and
when the determiner identifies that the communication anomaly is not in the second group, the determiner is configured to cancel an interruption of a flow of data transmitted from the second group to all of the plurality of groups other than the second group, the interruption of the flow of data being included in the predetermined communications interruption.

7. The communications interruption system according to claim 1, wherein
a vehicle including the in-vehicle network system has self-driving functionality including a function for pulling over the vehicle, and
the determiner is configured to:
determine whether to pull over the vehicle based on the contents of the communication anomaly detected when the determiner determines to execute the predetermined communications interruption; and
output an instruction to cause the vehicle to autonomously pull over when the determiner determines to pull over the vehicle.

8. The communications interruption system according to claim 1, wherein
a vehicle including the in-vehicle network system is manually operable, and
the determiner is configured to output an instruction that prompts an occupant of the vehicle to pull over manually when the determiner determines to pull over the vehicle.

9. The communications interruption system according to claim 7, further comprising:
an external communicator that is capable of communicating with an information processing system external to the in-vehicle network system, wherein
when the vehicle is pulled over in compliance with the instruction of the determiner,
the external communicator transmits, to the information processing system, information relating to data received from at least one of the plurality of communication devices included in a group from which data transmission to any other group is interrupted during the predetermined communications interruption.

10. The communications interruption system according to claim 9, wherein
the external communicator receives a signal from the information processing system for remotely controlling the vehicle,

11. A communications interruption method to be executed by a processor included in an information processing device connected to an in-vehicle network system in which it is possible to communicate data between a plurality of groups that each include a plurality of communication devices and a communication line to which the plurality of communication devices are connected, the method comprising:
receiving data from at least one of the plurality of communication devices included in a first group via the communication line included in the first group;
detecting a communication anomaly in the first group based on the data received, and determining whether to execute a predetermined communications interruption between the plurality of groups based on contents of the communication anomaly detected; and
executing the predetermined communications interruption when it is determined to execute the predetermined communications interruption, wherein
the predetermined communications interruption includes interrupting a flow of data transmitted from the first group to any group other than the first group.

12. A non-transitory computer-readable recording medium for use in a computer, the recording medium having a computer program recorded thereon for causing the processor to execute the communications interruption method according to claim 11.
